(19) United States
(12) Patent Application Publication
(10) Pub. No.: US 2026/0249463 A1
(43) Pub. Date: Aug. 27, 2026

(54) TEACHING DEVICE

(71) Applicant: FANUC CORPORATION, Yamanashi (JP)

(72) Inventors: Misaki ITO, Yamanashi (JP); Yuta NAMIKI, Yamanashi (JP)

(21) Appl. No.: 18/992,977

(22) PCT Filed: Aug. 2, 2022
(86) PCT No.: PCT/JP2022/029649

§ 371 Date: Jan. 10, 2025

(51) Int. Cl. B25J 9/16; G06F 9/451

(52) U.S. Cl. CPC B25J 9/1671; B25J 9/161; G06F 9/451

(57) ABSTRACT

A teaching device for performing program creation using icons representing functions constituting a control program for an industrial machine includes: a program creating unit for creating a program creation screen on which the icons are arranged and which is used to perform the program creation; and a disabling control unit for disabling the icons arranged on the program creating screen on the basis of an operation performed with respect to the icons.

### FIELD

The present disclosure relates to a teaching device.

### BACKGROUND

A technique for creating a control program using an icon representing a function constituting a control program of a robot in order to intuitively create the control program of the robot is known. For example, PTL 1 describes as follows: “FIG. 27 illustrates a motion program including an auxiliary icon that disables the motion instructed by a motion icon. A motion program 171 includes motion icons 171a to 171c. The motion program 171 includes an auxiliary icon 171p as an auxiliary symbol for disabling a motion command represented by a motion symbol. The motion instructed the motion icon 171b to which the auxiliary icon 171p is added can be disabled.” (paragraph 0102).

### CITATION LIST

### Patent Literature

[PTL 1] Japanese Unexamined Patent Publication (Kokai) No. 2021-091025 A

### SUMMARY

### Technical Problem

It is useful for a user who creates a control program to temporarily disable an icon in the control program and check the operation of the control program in the programming process of the control program. However, when the number of icons needed to be disabled in the control program increases, there is a possibility that an operation for disabling the icons may become complicated for a user. A teaching device that enables a user to disable icons in a control program by an operating manner easier for the user is desired.

One aspect of the present disclosure is a teaching device for performing program creation by an icon representing a function constituting a control program of an industrial machine, and the teaching device includes: a program creation unit configured to generate a program creation screen for performing programming by arranging an icon; and a disabling control unit configured to disable an icon arranged on the program creation screen, based on an operation with respect to the icon.

### Advantageous Effects of Invention

A user can disable, by an operating manner easier for the user, an icon intended to be disabled, and can more efficiently perform creation of a control program.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an example of a configuration of a robot system including a teaching device according to one embodiment.

FIG. 2 is a diagram illustrating a hardware configuration example of a robot controller and the teaching device.

FIG. 3 is a diagram illustrating a functional block diagram of the teaching device, the robot controller, and a visual sensor control device.

FIG. 4 is a diagram illustrating a configuration example of a program creation screen.

FIG. 5 is a diagram illustrating a first example related to disabling of an icon.

FIG. 6 is a diagram illustrating an example in which a pop-up menu is displayed when an icon is disabled.

FIG. 7 is a diagram illustrating a second example related to enabling and disabling of an icon.

FIG. 8 is a diagram illustrating a state where setting of a disabled icon is completed and thus the icon is enabled.

FIG. 9 is a diagram illustrating an example (third example) in which a disabled icon is hidden in a program creation region.

FIG. 10 is a diagram illustrating a display example when a disabled icon is minimized.

FIG. 11 is a diagram illustrating an example (fourth example) of disabling of an icon by an operation of designating a range.

FIG. 12 is a diagram illustrating an example (fifth example) in which an icon is disabled for a vision program.

FIG. 13 is a diagram illustrating another display manner of the program creation screen related to the vision program.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

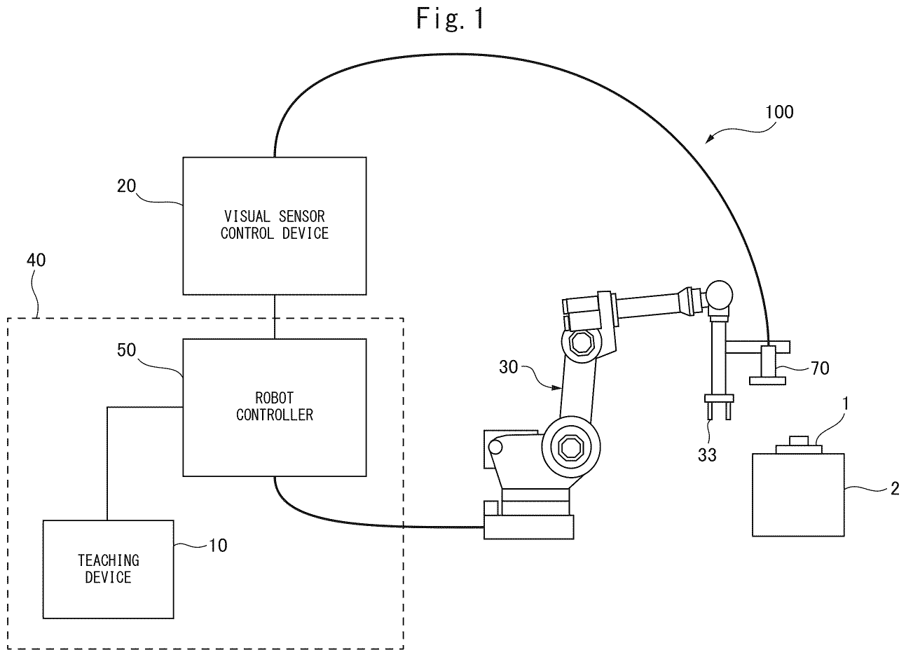

FIG. 1 is a diagram illustrating an example of a configuration of a robot system 100 including a teaching device 10 according to an embodiment. In the example of the configuration in FIG. 1, the robot system 100 includes a robot 30 including a hand (grasping device) 33 mounted on an arm tip portion, a robot controller 50 that controls the robot 30, the teaching device 10, a visual sensor 70 attached to the arm tip portion of the robot 30, and a visual sensor control device 20 that controls the visual sensor 70. The teaching device 10 is connected to the robot controller 50. In the configuration described above, the robot system 100 can detect a target object (hereinafter described as a workpiece) 1 on a worktable 2 by the visual sensor 70, and perform handling of the workpiece 1 with the hand 33 mounted on the robot 30. It should be noted that the visual sensor 70 may be a fixed camera having a position fixed in a workspace.

The robot 30 as an industrial machine is assumed to be a vertical articulated robot herein, but a robot of another type may be used. The robot 30 can perform desired work by an end effector attached to a wrist portion of an arm tip. The end effector is an external device exchangeable according to use, and is, for example, a hand, a welding gun, a tool, and the like. FIG. 1 illustrates an example in which the hand 33 as one example of the end effector is used.

The robot controller 50 controls a motion of the robot 30 according to a control program loaded in the robot controller 50 or a command input from the teaching device 10.

The teaching device 10 provides various functions for teaching a motion to the robot 30 (i.e., for performing programming). The teaching device 10 provides a function of performing programming by an icon representing a function (such as a movement to a designated position, and an input/output of IO) constituting a control program of a robot in order to intuitively teach the control program to the robot.

The visual sensor control device 20 has a function of controlling the visual sensor 70 and a function of executing image processing on an image captured by the visual sensor 70. The visual sensor control device 20 detects a position of the workpiece 1 from the image captured by the visual sensor 70, and provides a detection result to the robot controller 50. In this way, the robot controller 50 can perform handling of the workpiece 1 that is not positioned. It should be noted that a detection result may include a detection position of the workpiece 1, and an evaluation value (such as a detection score and a contrast of an image) related to the detection.

The visual sensor 70 may be a camera that captures a gray-scale image or a color image, or may be a stereo camera or a three-dimensional sensor that can acquire a distance image and a three-dimensional point group. The visual sensor control device 20 holds a model pattern of a workpiece, and can execute image processing of detecting a workpiece by pattern matching between an image of the workpiece in a captured image and the model pattern. In the present embodiment, it is assumed that calibration has been performed on the visual sensor 70, and it is assumed that the visual sensor control device 20 has calibration data that define a relative positional relationship between the visual sensor 70 and the robot 30. In this way, a position on an image captured by the visual sensor 70 can be converted to a position on a coordinate system (such as a robot coordinate system) fixed in a workspace.

It should be noted that, in FIG. 1, the visual sensor control device 20 is formed as a device provided separately from the robot controller 50, but a function as the visual sensor control device 20 may be embedded in the robot controller 50.

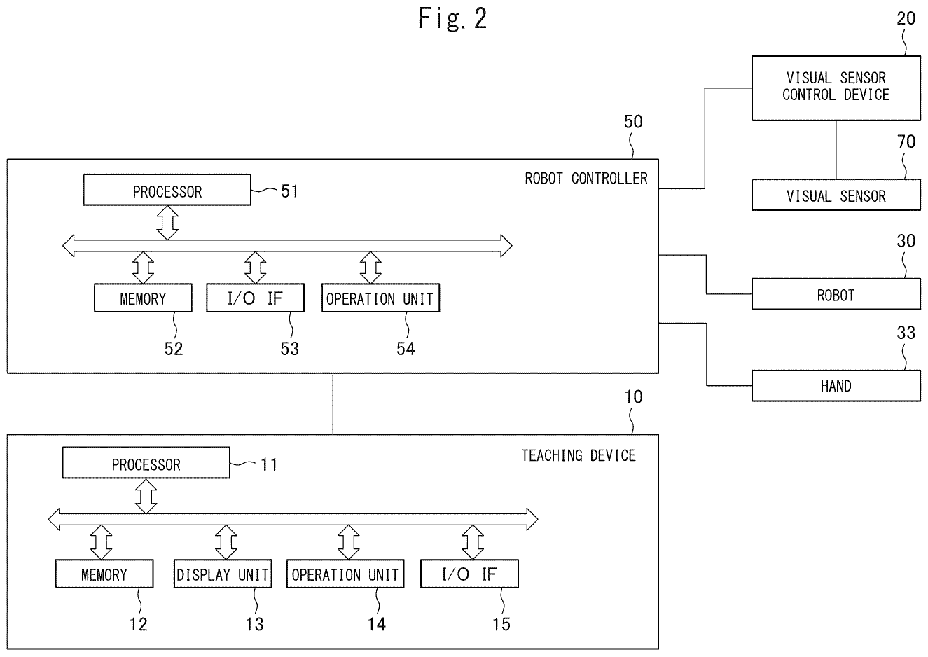

FIG. 2 is a diagram illustrating a hardware configuration example of the robot controller 50 and the teaching device 10. The robot controller 50 may have a configuration as a common computer in which a memory 52 (such as a ROM, a RAM, and a non-volatile memory), an input/output interface 53, an operation unit 54 including various operation switches, and the like are connected to a processor 51 via a bus. The teaching device 10 is used as a device for performing an operation input and a screen display for teaching the robot 30 (i.e., creating a control program). The teaching device 10 may have a configuration as a common computer in which a memory 12 (such as a ROM, a RAM, and a non-volatile memory), a display unit 13, an operation unit 14 formed of an input device such as a keyboard, a mouse, and a touch panel (software key), an input/output interface 15, and the like are connected to a processor 11 via a bus. It should be noted that an information processing device such as a tablet terminal and a smartphone may be used as the teaching device 10.

The visual sensor control device 20 may also have a configuration as a common computer in which a memory (such as a ROM, a RAM, and a non-volatile memory), an input/output interface, a display unit, an operation unit, and the like are connected to a processor via a bus.

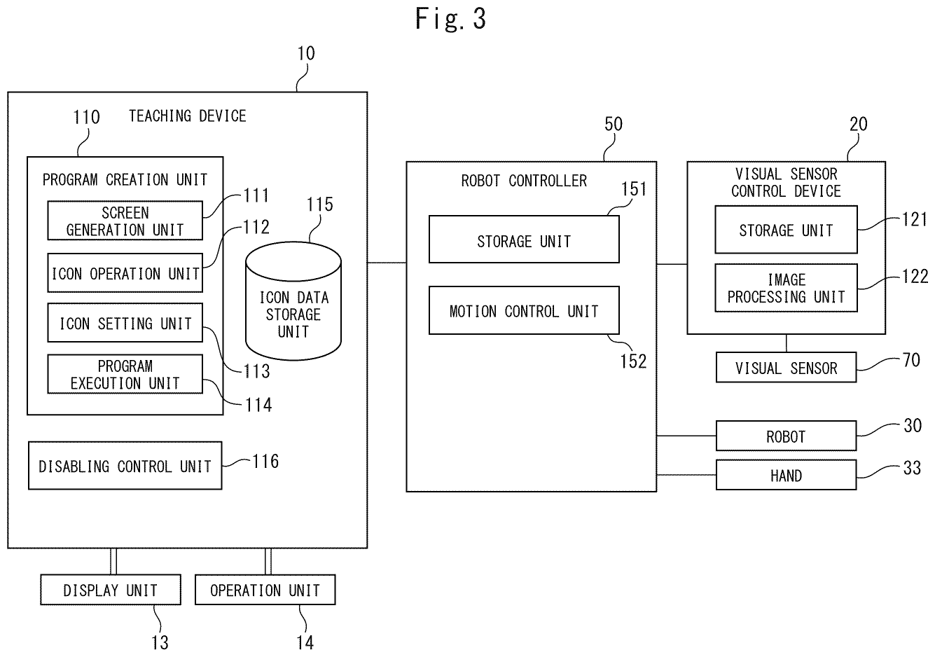

FIG. 3 illustrates a functional block diagram of the teaching device 10, the robot controller 50, and the visual sensor control device 20.

The visual sensor control device 20 includes a storage unit 121 and an image processing unit 122. The storage unit 121 stores various types of data (such as a model pattern) needed to execute image processing, a detection result, calibration data, and the like. The image processing unit 122 has a function of performing pattern matching and executing various other types of image processing.

The robot controller 50 includes a storage unit 151 and a motion control unit 152. The storage unit 151 stores various programs such as a control program, and various types of information used for robot control. The control program is provided from, for example, the teaching device 10. The motion control unit 152 controls a motion of the robot 30 and the like according to a command from the teaching device 10 or the control program. It should be noted that control by the motion control unit 152 includes control of the hand 33 and control of the visual sensor control device 20.

As illustrated in FIG. 3, the teaching device 10 includes a program creation unit 110 that provides various functions for creating a control program, an icon data storage unit 115, and a disabling control unit 116. The program creation unit 110 provides various functions for performing programming by using an icon representing a function constituting a control program of a robot. The program creation unit 110 includes a screen generation unit 111, an icon operation unit 112, an icon setting unit 113, and a program execution unit 114.

The screen generation unit 111 has functions of generating various operation screens (user interface screen) for performing program creation, and displaying the operation screen on a display screen of the display unit 13.

The icon operation unit 112 accepts various user operations on an icon displayed on the display screen.

The icon setting unit 113 provides a function for performing function setting of an icon. For example, the icon setting unit 113 accepts a user operation for performing function setting of an icon via the user interface screen.

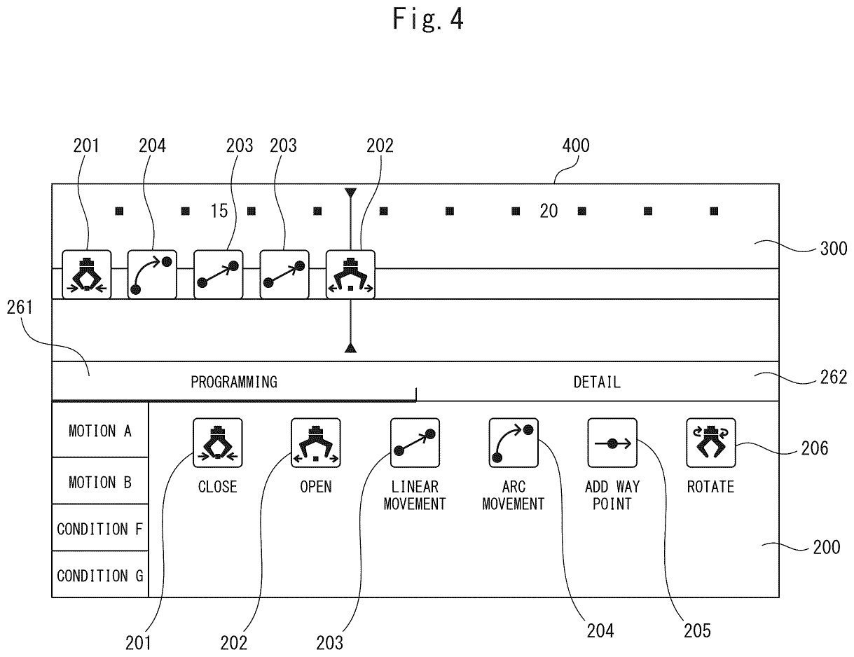

A configuration of a program creation screen provided by the program creation unit 110 will be described with reference to FIG. 4.

FIG. 4 illustrates an example of a program creation screen 400 generated by the screen generation unit 111 and displayed on the display unit 13 of the teaching device 10. As illustrated in FIG. 4, the program creation screen 400 includes an icon display region 200 for displaying a list of various icons that can be used for programming, and a program creation region 300 for creating a control program by arranging the icons in an order. In the example in FIG. 4, the icon display region 200 includes a hand close icon 201 representing a command for closing a hand, a hand open icon 202 representing a command for opening the hand, a linear movement icon 203, an arc movement icon 204, a way point addition icon 205, and a rotation icon 206 for rotating the hand.

A user can select an icon by, for example, putting a cursor on the icon. The user performs programming for example, by a drag-and-drop operation of selecting a desired icon from the icon display region 200 arranging the icon in the program creation region 300. In the example in FIG. 4, in the program creation region 300, the hand close icon 201, the arc movement icon 204, two linear movement icons 203, and the hand open icon 202 are arranged in this order. When the number of icons arranged in the program creation region 300 increases, the user can arrange the icon by scrolling the screen in a predetermined direction (a horizontal direction, a vertical direction, or the like). Such a user operation can be performed under support by the icon operation unit 112.

In the program creation screen 400, the user selects a programming tab 261 when the user performs programming. Meanwhile, by selecting an icon in the program creation region 300 and selecting a detail tab 262, the user can open a detailed setting screen for performing detailed setting (parameter setting) on the icon. Such detailed setting of a function of an icon can be performed under support by the icon setting unit. The user can instruct the teaching device 10 to execute a control program by performing a predetermined operation in a state where the icons are arranged in the program creation region 300.

The program execution unit 114 has the function of executing a program arranged in the program creation region 300. The program execution unit 114 generates a command of a robot by interpreting a program represented by icons arranged in the program creation region 300, and sends the command to the robot controller 50 to execute the program.

The icon data storage unit 115 stores various types of data about icons including detailed setting information about each icon.

The disabling control unit 116 provides a function of disabling and enabling an icon arranged in the program creation region 300 by cooperating with the program creation unit 110.

A specific example of processing of disabling and enabling of an icon by the disabling control unit 116 will be described below.

FIG. 5 is a diagram illustrating a first example related to disabling and enabling of an icon by the disabling control unit 116. As illustrated in FIG. 5, it is assumed that icons are arranged in the program creation region 300 and a program 501 is created. The program 501 includes three icons 211, 212, and 213. Herein, it is assumed that a user intends to disable the icon 213 and performs an operation for disabling the icon 213.

The disabling control unit 116 disables the icon 213 according to a predetermined operation on the icon 213. As the predetermined operation for disabling the icon 213, the disabling control unit 116 may be configured to accept operations as follows, for example.
(Operation 1) an operation of double-touching (quickly touching twice in a row) an icon,
(operation 2) an operation of holding down an icon,
(operation 3) an operation of minutely moving (vibrating) an icon to the left and the right while holding (dragging) the icon,
   and the like are possible. The above-described predetermined operations for disabling an icon may also be used as an operation for enabling a disabled icon.

In order to prevent occurrence of a situation where an icon is disabled by an unintended operation (false operation) of a user, when the operations of (operation 1) to (operation 3) described above are performed, a message image such as a pop-up image may be displayed on, for example, the program creation region 300 so as to notify the user that the icon is disabled. Further, in order to prevent such a pop-up image from being displayed each time an operation of disabling an icon is performed, the disabling control unit 116 may be configured to accept setting for not displaying such a pop-up image after a predetermined operation is performed.

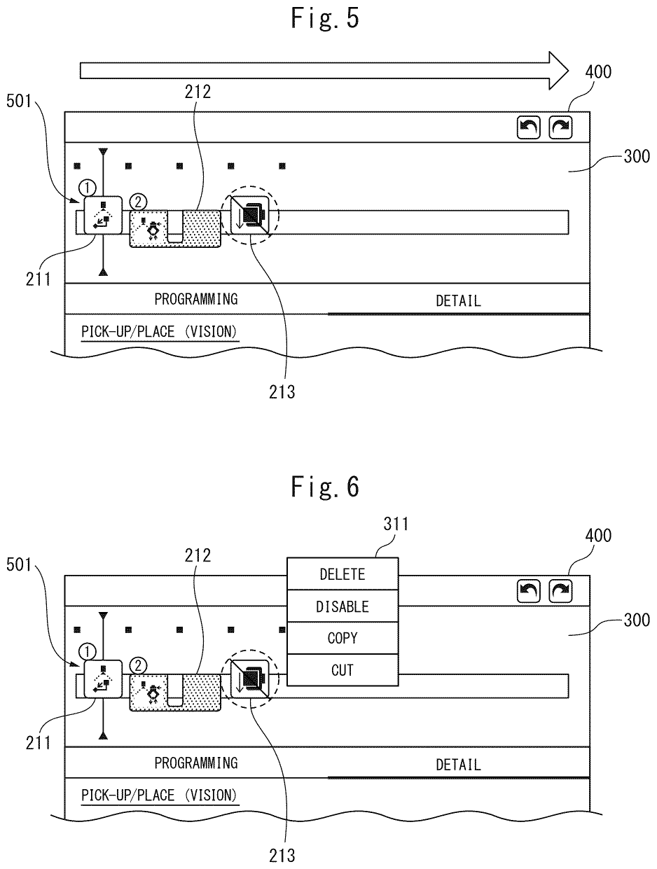

The disabling control unit 116 may be configured to present a menu screen that prompts a user to input an instruction on whether to disable an icon, in response to a selection operation on the icon or an operation for disabling the icon such as (operation 1) to (operation 3) described above, and disable the icon in response to the instruction for disabling by the user via such a menu screen. FIG. 6 illustrates an example of such a menu screen. It is assumed that a user performs an operation of selecting the icon 213 (for example, an operation of touching the icon). In this case, the disabling control unit 116 displays a menu screen 311 to prompt a use to input an instruction. The menu screen 311 includes an instruction for deletion, disabling, copy, and cut of the icon. When the icon 213 is desired to be disabled, the user selects “disable” from the menu screen 311. In response to selection of “disable”, the disabling control unit 116 disables the icon 213. With such a configuration, occurrence of a situation where an icon is accidentally disabled by an unintended operation of a user can be prevented.

When the icon 213 is disabled, the disabling control unit 116 performs display in such a way that a fact that the icon 213 is disabled can be visually recognized. FIGS. 5 and 6 illustrate a situation where in response to disabling of the icon 213, the icon 213 is in a display state of being provided with an oblique line (see a portion of a circle by a broken line in FIGS. 5 and 6).

It should be noted that, as a manner in which a disabled icon is displayed identifiably from a normal icon, various manners such as a manner in which contrast of a color of a disabled icon is reduced are possible in addition to the manner in which an oblique line is provided as described above.

It should be noted that the disabling control unit 116 may perform control in such a way that only a disabled icon can be deleted in the program creation region 300. In this way, an icon can be prevented from being deleted by a false operation, and operability can be improved.

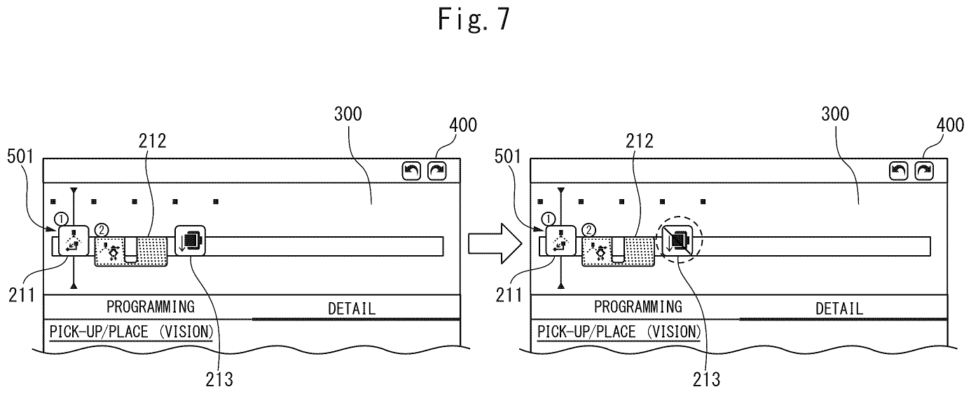

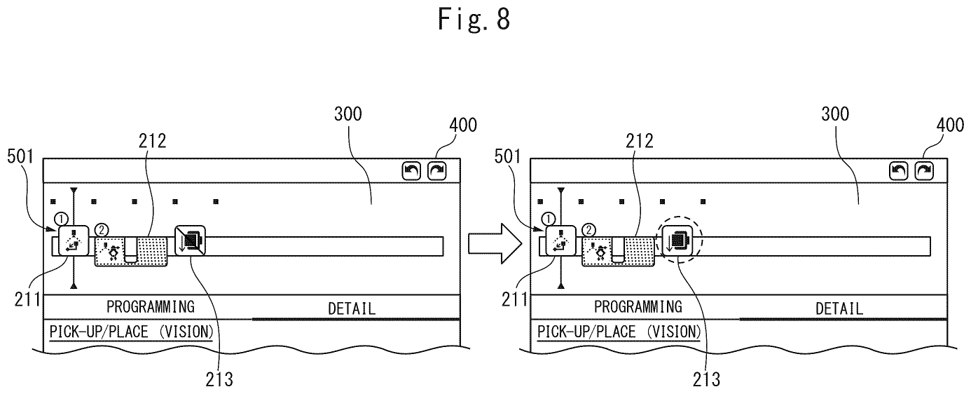

A second example related to enabling and disabling of an icon will be described with reference to FIGS. 7 and 8. The second example relates to a configuration for automatically disabling an icon in which setting is incomplete. A state where the icons 211, 212, and 213 are arranged in the program creation region 300 is illustrated on a left side in FIG. 7. Herein, it is assumed that the icon 213 is in a state of not yet being subjected to detailed setting. Herein, it is assumed that a user performs a predetermined operation to instruct the robot controller to execute the program 501. When setting of the icon 213 is incomplete, the disabling control unit 116 disables the icon 213 so as to prevent execution of the icon 213. For example, the disabling control unit 116 can recognize that setting of the icon 213 is incomplete by checking the icon data storage unit 115 for setting information about the icon 213.

A right side in FIG. 7 illustrates a display state where the icon 213 is provided with an oblique line in order to indicate that the icon 213 is disabled (see a portion of a circle by a broken line in FIG. 7). In other words, in this case, icons executed by the program execution unit 114 are the icons 211 and 212. In this way, occurrence of a situation where an icon of which the setting is incomplete is executed and thereby an error stop, display of a warning, or the like during execution of the control program can be avoided.

FIG. 8 illustrates a state where setting of the disabled icon 213 is completed and thus the icon 213 is enabled. As illustrated on a left side in FIG. 8, a state where setting of the icon 213 of the program 501 is incomplete and thus the icon 213 is disabled is assumed. Herein, it is assumed that a user activates a detailed setting screen of the icon 213 and completes detailed setting of the icon 213. In this case, the disabling control unit 116 enables the icon 213 in response to completion of setting of the icon 213. For example, the disabling control unit 116 can recognize that, by cooperating with the program creation unit 110 (icon setting unit 113), detailed setting of the icon 213 has been performed, and the disabling control unit 116 can recognize that, by referring to the icon data storage unit 115, setting of the icon 213 has been completed.

A right side in FIG. 8 illustrates a state where the icon 213 is enabled by the process described above and the oblique line provided to the icon 213 is deleted (see a portion of a circle by a broken line in FIG. 8). In this way, the user can immediately visually recognize that the icon 213 is enabled.

Herein, the example of disabling the icon of which the setting is incomplete when the program is executed has been described, but a timing at which an icon of which the setting is incomplete is disabled is not limited to such an example. For example, an example of disabling an icon of which the setting is incomplete at a timing at which the icon is arranged in the program creation region 300 is also possible.

The disabling control unit 116 may determine whether setting of an icon is incomplete according to whether setting of a basic item of setting items of the icon is completed. It should be noted that, when an icon includes, as a default value, a set value of such a basic item, the disabling control unit 116 can determine that setting of such an icon is completed.

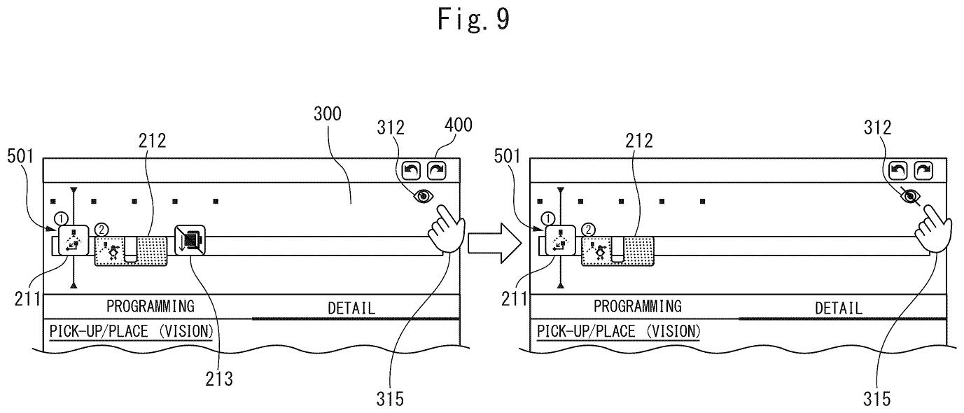

FIG. 9 relates to an example (third example) in which a disabled icon is hidden in the program creation region 300. The disabling control unit 116 can provide a function of hiding a disabled icon in the program creation region 300 in response to a predetermined user operation. In the example illustrated in FIG. 9, an eye mark 312 being an operation button for hiding an icon is arranged on the program creation screen 400. As illustrated on a left side in FIG. 9, a state where the icon 213 among the icons in the program creation region 300 is disabled is assumed. For example, a user can hide the disabled icon 213 by operating a cursor 315 to select the eye mark 312.

A state where the icon 213 is hidden in the program creation region 300 is illustrated on a right side in FIG. 9. As illustrated on the right side in FIG. 9, when the disabled icon is in the hidden state, processing of providing an oblique line to the eye mark 312 and the like may be executed in such a way that the hidden state can be visually recognized.

An advantage of capable of making contents of a program in the program creation region 300 easy to see can be achieved by the function of hiding a disabled icon. In particular, the function is useful when there are many disabled icons in the program creation region 300, and the like.

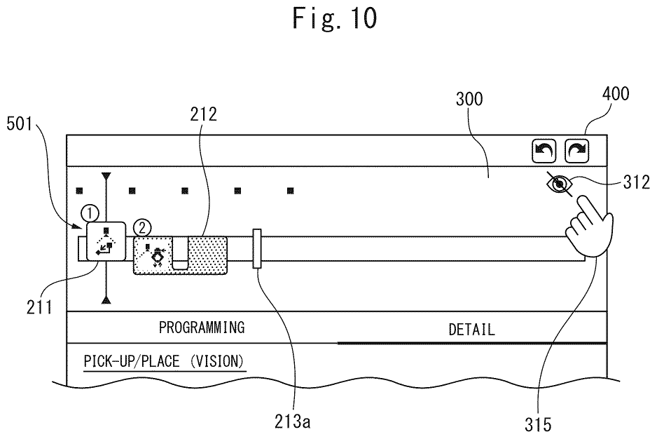

It should be noted that, when a disabled icon is completely hidden, a user may forget presence of the icon. In order for the user not to forget presence of a disabled icon, the disabled icon may be minimized instead of being completely hidden. FIG. 10 illustrates a state where the user selects the eye mark 312, and thus the disabled icon 213 is minimized and displayed as a minimized icon 213a. In this way, by the function of minimizing a disabled icon, an advantage of avoiding occurrence of a situation where a user forgets presence of the disabled icon can be acquired together with the function of making a program content easy to see.

It should be noted that the example of minimizing one disabled icon has been described herein, but, when a plurality of disabled icons are continuously arranged in a program, the plurality of continuous disabled icons may be displayed collectively as one minimized icon.

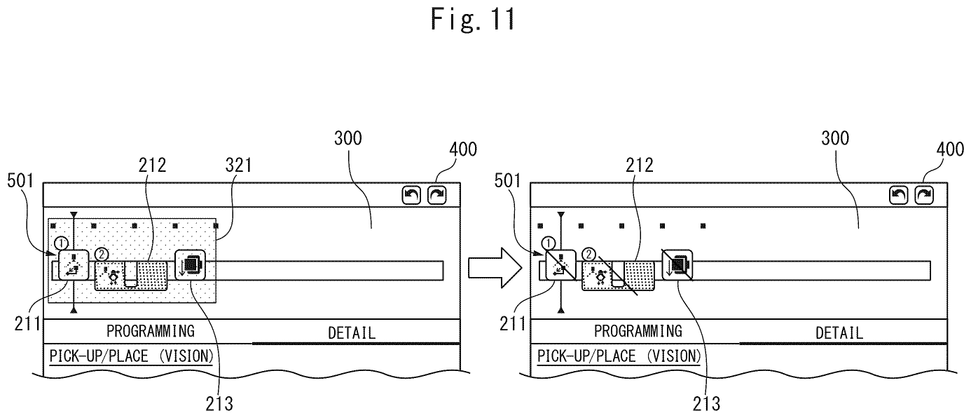

FIG. 11 is a diagram illustrating an example (fourth example) of disabling of icons by an operation of designating a range including icons to be disabled by a user. As illustrated in FIG. 11, the disabling control unit 116 accepts an operation of designating a range including icons to be disabled in the program creation region 300. Herein, it is assumed that an operation of designating a rectangular selection range 321 is performed by a user operation as illustrated on a left side in FIG. 11. It should be noted that such an operation of designating a selection range may be, for example, a drag operation by a screen touch, or a mouse operation. The disabling control unit 116 disables icons located in the selection range 321. Herein, the icons 211 to 213 are included in the selection range 321. A right side in FIG. 11 illustrates a state where the icons 211 to 213 included in the selection range 321 are disabled. It should be noted that the operation of designating a range may be used as an operation for enabling a disabled icon.

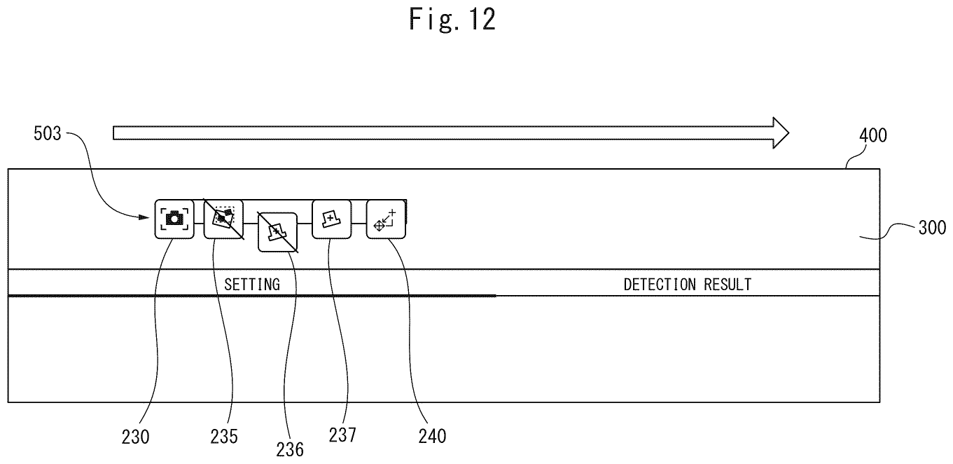

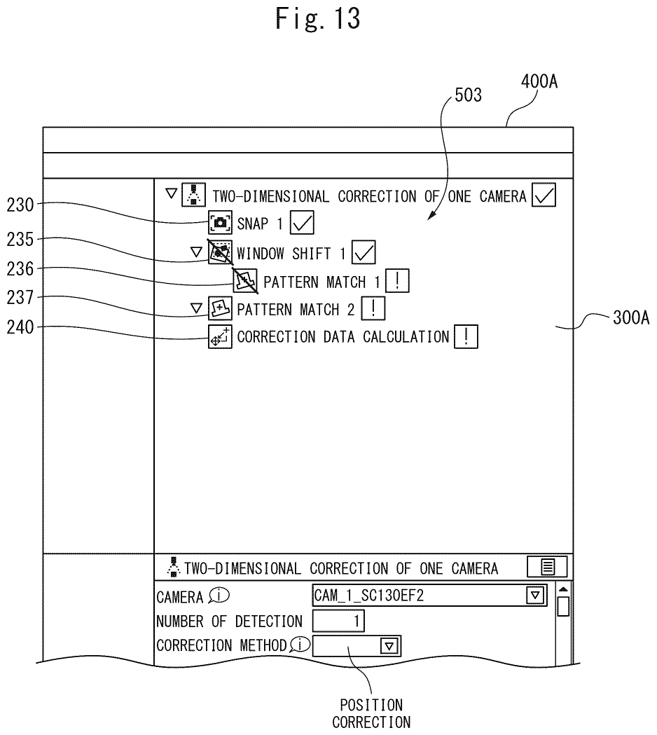

FIGS. 12 and 13 are diagrams illustrating an example (fifth example) related to disabling of an icon for a program providing a function of detecting or inspecting a workpiece by the visual sensor 70. It should be noted that, hereinafter, a program including capturing of an image by the visual sensor and processing of a captured image is referred to as a vision program. As illustrated in FIG. 12, a vision program 503 includes a snap icon 230, a “window shift” icon 235, a “pattern match 1” icon 236, a “pattern match 2” icon 237, and a “correction data calculation” icon 240.

FIG. 13 illustrates a screen example of a program creation screen 400A that displays the vision program 503 illustrated in FIG. 12 in a display manner different from the program creation screen 400 illustrated in FIG. 12. The program creation screen 400A illustrated in FIG. 13 includes a program creation region 300A displayed in a style in which icons are arranged and displayed in the vertical direction. It should be noted that an example of arranging and displaying the vision program 503 in the vertical direction in the program creation region 300A is illustrated herein.

FIGS. 12 and 13 illustrate a state where the “window shift” icon 235 and the “pattern match 1” icon 236 in the program are disabled.

The “window shift” icon 235 and the “pattern match 1” icon 236 are icons functionally in a parent-child relationship. Specifically, the “window shift” icon 235 provides a function of shifting a detection region in a captured image, and the “pattern match 1” icon 236 provides a function of performing target object detection by pattern matching in the set detection region. The disabling control unit 116 may be configured to automatically disable a child icon when a parent icon among icons in a parent-child relationship is disabled. In a case of the present example, when a user disables the “window shift” icon 235, the “pattern match 1” icon 236 is also automatically disabled.

In this way, when a parent icon is disabled, a child icon is automatically disabled, and thus a burden on a user who performs programming is reduced, and program creation is made more efficient.

It should be noted that, in addition to a case of a parent-child relationship, when one of a plurality of icons having a certain relationship is disabled by a user operation, another icon of the plurality of icons may be automatically disabled. For example, the icon 212 illustrated in FIG. 5 is an icon that is a wide icon and can provide an integrated function in a state where other icons are arranged within the range of the icon 212. In this case, an icon arranged within the range of the icon 212 may be automatically disabled in response to disabling of the icon 212.

In a program such as the vision program 503 described above, an essential icon for achieving the function of the program is present. In a case of the vision program 503, the snap icon 230 corresponding to a capturing function of a camera, the “pattern match 2” icon 237 for detecting a target object, and the “correction data calculation” icon 240 for performing calculation of correction data, based on a detection result, correspond to the essential icons. The disabling control unit 116 may perform control in such a way as not to disable the essential icon in the vision program. For example, such a function can be achieved by (1) storing, in advance, information in which an essential icon is associated with the type of a program, and (2) determining whether an icon can be disabled by referring to the information when an operation of disabling the icon is performed.

As described above, according to the present embodiment, a user can disable, by an operating manner easier for the user, an icon intended to be disabled, and can more efficiently perform creation of a control program.

The present invention has been described above by using the typical embodiments, but it will be understood by those of ordinary skill in the art that changes, other various changes, omission, and addition may be made in each of the embodiments described above without departing from the scope of the present invention.

Distribution of functions in each device illustrated in the functional block diagram in FIG. 3 is an example, and various modification examples regarding distribution of functions are possible. For example, a configuration in which a part (the program creation unit and the icon data storage unit) of the functions in the teaching device 10 is arranged on the robot controller 50 side is also possible.

As illustrated in FIG. 1, the entire function of the teaching device 10 and the robot controller 50 may be defined as the teaching device 40.

The configuration of the teaching device in the embodiment described above can be applied to not only programming of a robot but also programming of various industrial machines.

The functional block of the teaching device, the robot controller, and the visual sensor control device illustrated in FIG. 3 may be achieved by executing various types of software stored in a storage device by the processor of the teaching device, the robot controller, and the visual sensor control device, or may be achieved by a configuration in which hardware such as an application specific integrated circuit (ASIC) is a main body.

### Reference Signs List

10 Teaching device
20 Visual sensor control device
30 Robot
33 Hand
50 Robot controller
11, 51 Processor
12, 52 Memory
15, 53 Input/output interface
13 Display unit
14, 54 Operation unit
100 Robot system
110 Program creation unit
111 Image generation unit
112 Icon operation unit
113 Icon setting unit
114 Program execution unit
115 Icon data storage unit
116 Disabling control unit
121 Storage unit
122 Image processing unit
151 Storage unit
152 Motion control unit
200 Icon display region
300, 300A Program creation region
400, 400A Program creation screen

1. A teaching device for performing programming by using an icon representing a function constituting a control program of an industrial machine, the teaching device comprising:
a program creation unit configured to generate a program creation screen for performing programming by arranging an icon; and
a disabling control unit configured to disable an icon arranged on the program creation screen, based on an operation with respect to the icon.

2. The teaching device according to claim 1, wherein
the disabling control unit enables the icon, based on an operation with respect to a disabled icon arranged on the program creation screen.

3. The teaching device according to claim 1, wherein
the disabling control unit automatically disables an icon which is arranged on the program creation screen and of which setting is incomplete.

4. The teaching device according to claim 3, wherein
the disabling control unit disables the icon of which setting is incomplete in response to an instruction for execution of a control program.

5. The teaching device according to claim 3, wherein
the disabling control unit disables the icon of which setting is incomplete in response to a fact that the icon of which setting is incomplete is arranged on the program creation screen.

6. The teaching device according to claim 3, wherein
the disabling control unit enables a disabled icon of which setting is incomplete in response to completion of setting of the icon.

7. The teaching device according to claim 1, wherein
the operation for disabling an icon includes an operation of designating a range for selecting an icon needed to be disabled on the program creation screen.

8. The teaching device according to claim 1, wherein
the disabling control unit sets a disabled icon in a hidden state, based on a predetermined user operation.

9. The teaching device according to claim 1, wherein
the disabling control unit sets a disabled icon in a state of minimize display, based on a predetermined user operation.

10. The teaching device according to claim 1, wherein
the disabling control unit displays an image representing a message indicating that an icon is to be disabled when the icon is disabled in response to the operation for disabling an icon.

11. The teaching device according to claim 1, wherein
the disabling control unit displays a menu screen including an instruction for disabling of an icon in response to the operation for disabling an icon, and disables the icon in response to reception of an instruction for disabling of an icon via the menu screen.

12. The teaching device according to claim 1, wherein
the disabling control unit can delete only a disabled icon in the program creation screen.

13. The teaching device according to claim 1, wherein
the disabling control unit automatically disables an icon having a specific relationship with an icon disabled by the operation for disabling an icon.

14. The teaching device according to claim 1, wherein
the control program is a program including capturing an image by a visual sensor and processing of a captured image.
